(19) United States
(12) Patent Application Publication
(10) Pub. No.: US 2023/0332998 A1
(43) Pub. Date: Oct. 19, 2023

(54) PARTICLE ANALYSIS DEVICE AND METHOD FOR PRODUCING SAME

(71) Applicant: NOK CORPORATION, Tokyo (JP)

(72) Inventors: Takumi YOSHITOMI, Fujisawa (JP); Yuki MUROTA, Fujisawa (JP); Naohiro FUJISAWA, Fujisawa (JP); Yuto TOKI, Fujisawa (JP)

(21) Appl. No.: 18/027,839

(22) PCT Filed: Aug. 23, 2021
(86) PCT No.: PCT/JP2021/030761

§ 371 Date: Mar. 22, 2023

(30) Foreign Application Priority Data
Sep. 29, 2020 (JP) 2020-163035

(51) Int. Cl. G01N 15/10

(52) U.S. Cl. CPC G01N 15/1031

(57) ABSTRACT

A particle analyzer includes: an upper liquid space for storing first liquid; a lower liquid space for storing second liquid; a connection hole connecting the liquid spaces; a first inlet hole supplying the first liquid to the upper liquid space; a first outlet hole for exhausting air from the upper liquid space; a second inlet hole supplying the second liquid to the lower liquid space; a second outlet hole for exhausting air from the lower liquid space; first and second electrodes respectively applying a potential to the first liquid in the upper liquid space the second liquid in the lower liquid space; first and second lids respectively arranged at the opening of the first outlet hole and at the opening of the second outlet hole, and both lids being formed of a film allowing air to pass but not allowing liquids to pass.

### CROSS REFERENCE TO RELATED APPLICATIONS

The present application is a national phase application of International Patent Application No. PCT/JP2021/030761 filed on Aug. 23, 2021, which claims the benefit of Japanese Patent Application No. 2020-163035, filed on Sep. 29, 2020. The contents of the above applications are incorporated herein by reference in their entirety.

### BACKGROUND

### Technical Field

The present disclosure relates to a particle analyzer for analyzing a particle contained in a liquid.

### Related Art

Particle analyzers having two spaces are being proposed in order to analyze particles such as exosomes, pollen, viruses, and bacteria (for example, see Japanese Patent Application Publication No. 2014-174022, Japanese Patent Application Publication No. 2017-156168, International Publication No. WO 2013/136430 and International Publication No. WO 2013/137209). Particle analyzers of this type have a hole connecting the two spaces, and a liquid is stored in one of the spaces while a liquid containing particles to be analyzed is stored in the other space. The spaces are given different potentials and the particles pass through the hole due to electrophoresis. When the particles pass through the hole, a value of a current flowing through the liquids changes. By observing a change in the current value, characteristics (for example, a type, a shape, and a size) of the particles having passed through the hole are analyzed. For example, the number of particles of a certain type contained in the liquid can be measured.

The particle analyzer disclosed in WO 2013/137209 has two inlet holes and two outlet holes for two liquids stored in two spaces. For example, a liquid can be guided to a space via the inlet hole using a syringe or a pipette. At this point, it may be desirable that the liquids do not squirt out from the outlet hole. An example is a case where a liquid contains viruses or bacteria.

In consideration thereof, the present disclosure provides a particle analyzer capable of preventing a liquid used for an analysis from being scattered outward and a method of easily manufacturing the analyzer.

### SUMMARY

An aspect of the present disclosure provides a particle analyzer. The particle analyzer includes: an upper liquid space in which a first liquid is to be stored; a lower liquid space which is arranged below the upper liquid space and in which a second liquid is to be stored; a connection hole connecting the upper liquid space and the lower liquid space to each other; a first inlet hole which has an opening that opens on an upper surface of the particle analyzer, which extends from the upper surface to the upper liquid space, and which is for supplying the first liquid to the upper liquid space; a first outlet hole which has an opening that opens on the upper surface, which extends from the upper surface to the upper liquid space, and through which air is to be exhausted from the upper liquid space; a second inlet hole which has an opening that opens on the upper surface, which extends from the upper surface to the lower liquid space, and which is for supplying the second liquid to the lower liquid space; a second outlet hole which has an opening that opens on the upper surface, which extends from the upper surface to the lower liquid space, and through which air is to be exhausted from the lower liquid space; a first electrode applying a potential to the first liquid in the upper liquid space; a second electrode applying a potential to the second liquid in the lower liquid space; a first lid which is arranged at the opening of the first outlet hole and which is formed of a film allowing air to pass but not allowing liquids to pass; and a second lid which is arranged at the opening of the second outlet hole and which is formed of a film allowing air to pass but not allowing liquids to pass.

In this aspect, the first liquid can be supplied to the upper liquid space through the first inlet hole. At this point, air existing in the upper liquid space is exhausted through the first outlet hole and to thereby enable the first liquid to easily enter the upper liquid space from the first inlet hole. The first lid which is formed of a film allowing air to pass but not allowing liquids to pass is provided at the opening of the first outlet hole. Therefore, even when energy for introducing the first liquid to the upper liquid space is excessively strong, the first liquid is blocked by the first lid and does not scatter to the outside. Since the first lid allows the passage of air, the first lid does not prevent the first liquid from entering the upper liquid space from the first inlet hole. In a similar manner, the second liquid can be supplied to the lower liquid space through the second inlet hole. At this point, air existing in the lower liquid space is exhausted through the second outlet hole and thereby to enable the second liquid to easily enter the lower liquid space from the second inlet hole. The second lid which is formed of a film allowing air to pass but not allowing liquids to pass is provided at the opening of the second outlet hole. Therefore, even when energy for introducing the second liquid to the lower liquid space is excessively strong, the second liquid is blocked by the second lid and does not scatter to the outside. Since the second lid allows the passage of air, the second lid does not prevent the second liquid from entering the lower liquid space from the second inlet hole.

### BRIEF DESCRIPTION OF THE DRAWINGS

FIG. 1 is a perspective view showing a particle analyzer according to a first embodiment of the present disclosure.

FIG. 2 is a side view of the particle analyzer shown in FIG. 1.

FIG. 3 is a plan view of the particle analyzer shown in FIG. 1.

FIG. 4 is a conceptual diagram showing a principle of analysis of a particle using the particle analyzer shown in FIG. 1.

FIG. 5 is an exploded view of the particle analyzer shown in FIG. 1 as viewed from obliquely above.

FIG. 6 is an enlarged plan view of the particle analyzer shown in FIG. 1.

FIG. 7 is a sectional view taken along line VII-VII in FIG. 6.

FIG. 8 is a perspective view showing a particle analyzer according to a second embodiment of the present disclosure.

FIG. 9 is an exploded view of the particle analyzer shown in FIG. 8.

FIG. 10 is a sectional view of a part of the particle analyzer shown in FIG. 8.

FIG. 11 is a sectional view of a part of a particle analyzer according to a third embodiment of the present disclosure.

FIG. 12 is a diagram showing steps for manufacturing a particle analyzer according to a fourth embodiment of the present disclosure.

FIG. 13 is a diagram showing steps for manufacturing a particle analyzer according to a fifth embodiment of the present disclosure.

FIG. 14 is a sectional view showing a plate manufactured by the steps shown in FIG. 13.

### DETAILED DESCRIPTION

Hereinafter, various embodiments related to the present disclosure will be described with reference to the accompanying drawings. Note that the scale of the drawings is not necessarily accurate and a part of the features may sometimes be exaggerated or omitted.

### First Embodiment

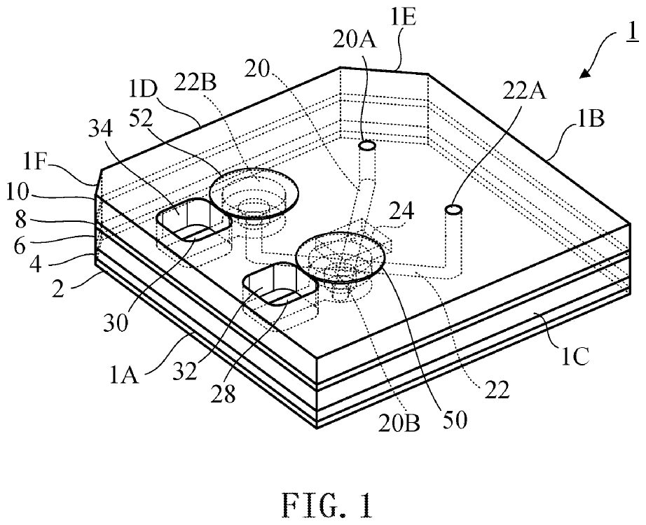

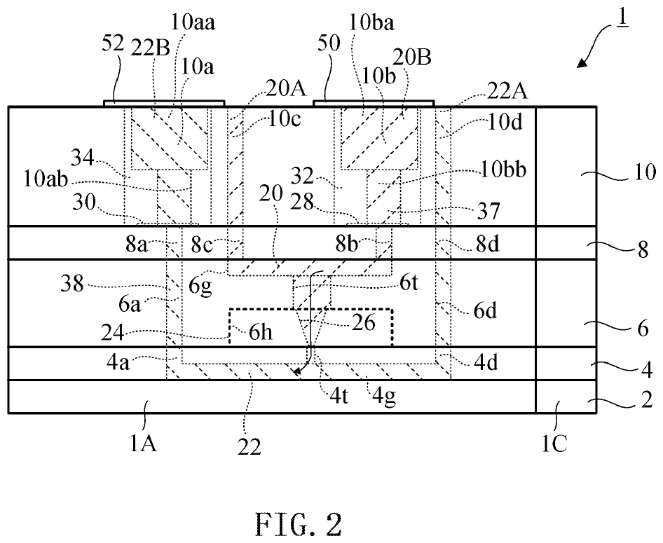

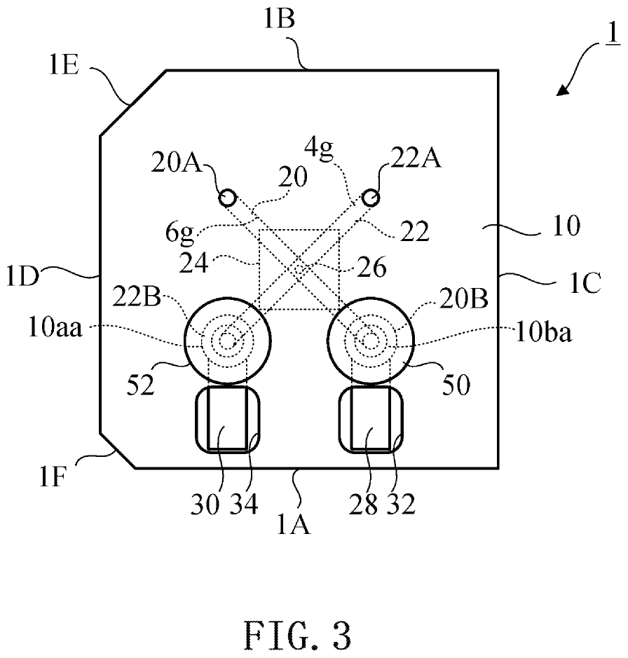

As shown in FIG. 1, a particle analyzer 1 according to a first embodiment has a shape of a hexagonal prism and has six side surfaces 1A, 1B, 1C, 1D, 1E, and 1F. As shown in the plan view of FIG. 3, when viewed from above, the particle analyzer 1 has a hexagonal profile created by cutting out two corners of an approximate square. FIG. 2 is a side view of the particle analyzer 1 showing two side surfaces 1A and 10.

As shown in FIGS. 1, 2, and 3, the particle analyzer 1 has an upper liquid space 20, a lower liquid space 22, and a connection hole 26. The liquid spaces 20 and 22 respectively extend straight in a horizontal direction, and a first liquid 37 is stored in the upper liquid space 20, a second liquid 38 is stored in the lower liquid space 22. In FIG. 2, the first liquid 37 stored in the upper liquid space 20 and the second liquid 38 stored in the lower liquid space 22 are indicated by different hatch patterns. The lower liquid space 22 is arranged below the upper liquid space 20 and the liquid spaces 20 and 22 are connected to each other by the connection hole 26. As shown in FIG. 3, the liquid spaces 20 and 22 are mutually orthogonal in a plan view.

In addition, the particle analyzer 1 has a first inlet hole 20A, a first outlet hole 20B, a second inlet hole 22A, and a second outlet hole 22B. Each of the first inlet hole 20A, the first outlet hole 20B, the second inlet hole 22A, and the second outlet hole 22B has an opening which opens on an upper surface of the particle analyzer 1.

The first inlet hole 20A and the first outlet hole 20B extend vertically from the upper surface of the particle analyzer 1 to the upper liquid space 20 and the first liquid 37 flows through the inside of these holes. The first inlet hole 20A, the first outlet hole 20B, and the upper liquid space 20 form a single storage tank for the first liquid 37. When supplying the first liquid 37 to the upper liquid space 20, the first inlet hole 20A is used as an introduction port of the first liquid 37 and the first outlet hole 20B is used as an outlet of air which is pushed out from the upper liquid space 20 by the first liquid 37.

The second inlet hole 22A and the second outlet hole 22B extend vertically from the upper surface of the particle analyzer 1 to the lower liquid space 22 and the second liquid 38 flows through the inside of these holes. The second inlet hole 22A, the second outlet hole 22B, and the lower liquid space 22 form another single storage tank for the second liquid 38. When supplying the second liquid 38 to the lower liquid space 22, the second inlet hole 22A is used as an introduction port of the second liquid 38 and the second outlet hole 22B is used as an outlet of air which is pushed out from the lower liquid space 22 by the second liquid 38.

Furthermore, the particle analyzer 1 has a first electrode 28 and a second electrode 30. The first electrode 28 applies a potential to the first liquid 37 inside the upper liquid space 20 through the first outlet hole 20B. The second electrode 30 applies a potential which differs from the first electrode 28 to the second liquid 38 inside the lower liquid space 22 through the second outlet hole 22B. For example, the second electrode 30 is an anode and the first electrode 28 is a cathode. Since the liquid spaces 20 and 22 are communicated via the connection hole 26, a current flows through the first liquid 37 and the second liquid 38 inside the liquid spaces 20 and 22.

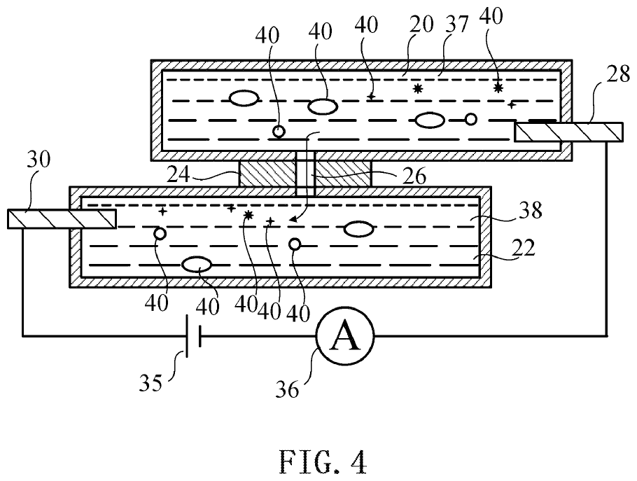

FIG. 4 schematically shows a principle of analysis of a particle using the particle analyzer 1. The upper liquid space 20 stores the first liquid 37 containing a particle 40 to be analyzed. The lower liquid space 22 stores the second liquid 38 which does not originally contain the particle 40. However, the second liquid 38 stored in the lower liquid space 22 may contain the particle 40. The liquid spaces 20 and 22 are connected to each other by the connection hole 26 which is a through-hole formed in a chip (nanopore chip) 24. A direct-current (DC) power supply 35 and an ammeter 36 are connected to the first electrode 28 and the second electrode 30. The DC power supply 35 is, for example, a battery, the DC power supply 35 is not limited to a battery.

Due to electrophoresis attributable to a difference in potential applied to the electrodes 28 and 30, the particle 40 contained in the first liquid 37 in the upper liquid space 20 passes through the connection hole 26 and flows into the second liquid 38 inside the lower liquid space 22. When the particle 40 passes through the connection hole 26, a current value of a current flowing through the first liquid 37 and the second liquid 38 changes. The change in the current value can be observed using the ammeter 36. By observing the change in the current value, characteristics (for example, a type, a shape, and a size) of the particle 40 having passed through the connection hole 26 are analyzed. For example, the number of particles 40 of a certain type contained in the first liquid 37 can be measured. The particle analyzer 1 may be used in order to analyze various particles including exosomes, pollen, viruses, and bacteria.

As shown in FIGS. 1, 2, and 3, the particle analyzer 1 includes hexagonal plates 2, 4, 6, 8, and 10 which are stacked on each other. Preferably, a part of or all of these plates are formed of a transparent or translucent material and stored states of the first liquid 37 and the second liquid 38 inside the cavities (the first inlet hole 20A, the first outlet hole 20B, the second inlet hole 22A, the second outlet hole 22B, and the liquid spaces 20 and 22) of the particle analyzer 1 are observable from the outside of the particle analyzer 1. However, the stored states of the liquids need not necessarily be observable and the plates may be opaque.

The plates 2, 4, 6, 8, and 10 are formed of an electrically and chemically inert material with insulating properties. Each plate may be formed of a rigid material or an elastic material. Examples of a preferable rigid material include resin materials such as polycarbonate, polyethylene terephthalate, acryl, cyclic olefin, polypropylene, polystyrene, polyester, and polyvinyl chloride. Examples of a preferable elastic material include elastomers such as silicone rubber or urethane rubber containing PDMS (polydimethylsiloxane).

However, for the purpose of securing adhesion between an upper plate and a lower plate, stacking a plate made of a rigid material on top of a plate made of a rigid material is not preferable. A plate made of a rigid material or a plate made of an elastic material may be stacked on top of a plate made of an elastic material. All of the plates 2, 4, 6, 8, and 10 may be made of an elastic material.

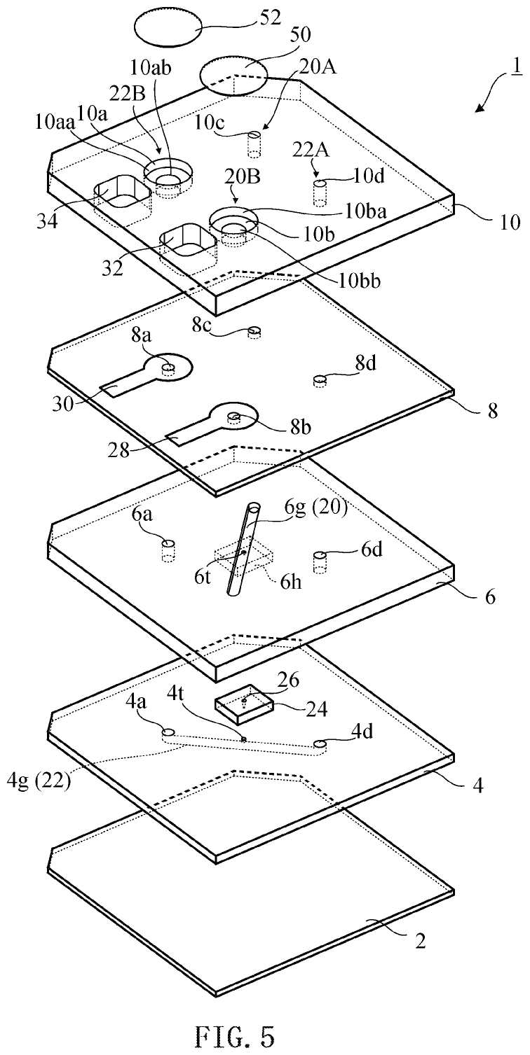

As shown in FIG. 5, neither grooves nor holes are formed in the plate 2 being a lowermost layer.

A horizontal groove 4g is formed at center of a lower surface of the next plate 4. Once the plates 2 and 4 are connected, the groove 4g forms the lower liquid space 22. A communication hole 4t which penetrates in the vertical direction is formed at center of the groove 4g. The communication hole 4t communicates the lower liquid space 22 (the groove 4g) and the connection hole 26 of the chip 24 with each other. In addition, through-holes 4a and 4d which have a cylindrical shape and which penetrate in the vertical direction are formed in the plate 4. The through-holes 4a and 4d have a same diameter. The through-hole 4a communicates with one end section of the groove 4g and the through-hole 4d communicates with another end section of the groove 4g.

A recessed portion 6h which is a rectangular parallelopiped is formed at center of a lower surface of the next plate 6. The recessed portion 6h houses the chip 24 having the connection hole 26. The chip 24 is fitted into the recessed portion 6h. The chip 24 may be detachable (replaceable) from the recessed portion 6h or undetachable (non-replaceable). A horizontal groove 6g is formed at center of an upper surface of the plate 6. Once the plates 6 and 8 are connected, the groove 6g forms the upper liquid space 20. A communication hole 6t which penetrates in the vertical direction is formed at center of the groove 6g. The communication hole 6t communicates the upper liquid space 20 (the groove 6g) and the connection hole 26 of the chip 24 with each other. Cross sections of the communication holes 4t and 6t and the connection hole 26 are circular, however, the cross sections of the holes may not be circular.

In addition, through-holes 6a and 6d which have a cylindrical shape and which penetrate in the vertical direction are formed in the plate 6. The through-holes 6a and 6d have a same diameter as the through-holes 4a and 4d. The through-hole 6a communicates with the through-hole 4a of the plate 4 directly below and, eventually, the one end section of the groove 4g, and the through-hole 6d communicates with the through-hole 4d and, eventually, the other end section of the groove 4g.

The chip (nanopore chip) 24 is a plate which is a rectangular parallelopiped such as a square. The connection hole 26 which penetrates in the vertical direction is formed at the center of the chip 24. The chip 24 may be formed of an electrically and chemically inert material with insulating properties such as glass, sapphire, a ceramic, a resin, an elastomer, SiO₂, SiN, or Al₂O₃. The chip 24 is preferably formed of a material such as glass, sapphire, a ceramic, SiO₂, SiN, or Al₂O₃ which is harder than the material of the plates 2, 4, 6, 8, and 10, however, the chip 24 may be formed of a resin or an elastomer. A user can select an appropriate chip 24 in accordance with an application of the particle analyzer 1. For example, by preparing a plurality of chips 24 having connection holes 26 with different dimensions or shapes and selecting the chip 24 to be fitted into the recessed portion, the particle 40 being an analyzed object can be changed.

In order to facilitate passage of liquid through the connection hole 26 without clogging, a hydrophilic treatment is preferably applied to the chip 24. For example, the hydrophilic treatment involves irradiating the chip 24 with oxygen plasma or ultraviolet light. The ultraviolet light may be radiated in the form of a laser beam.

Through-holes 8a, 8b, 8c, and 8d which have a cylindrical shape and which penetrate in the vertical direction are formed in the next plate 8. The through-holes 8a, 8b, 8c, and 8d have a same diameter as the through-holes 4a, 4d, 6a, and 6d. The through-hole 8a communicates with the through-hole 6a of the plate 6 directly below and the through-hole 8d communicates with the through-hole 6d of the plate 6. The through-hole 8b communicates with one end section of the groove 6g of the plate 6 and the through-hole 8c communicates with another end section of the groove 6g. The electrodes 28 and 30 are arranged in parallel on an upper surface of the plate 8, and the first electrode 28 applies a potential to the first liquid 37 inside the through-hole 8b and the second electrode 30 applies a potential to the second liquid 38 inside the through-hole 8a.

Through-holes 10a, 10b, 10c, and 10d which penetrate in the vertical direction are formed in the plate 10 being an uppermost layer. The through-holes 10a, 10b, 10c, and 10d respectively communicate with the through-holes 8a, 8b, 8c, and 8d of the plate 8 directly below.

In addition, a first electrode bar insertion hole 32 in which the first electrode 28 below the plate 10 is exposed and a second electrode bar insertion hole 34 in which the second electrode 30 is exposed are formed in the plate 10 being the uppermost layer. Each of the electrode bar insertion holes 32 and 34 has an opening which opens on the upper surface of the particle analyzer 1 and penetrates the plate 10 and extends to the electrode 28 or 30 from the upper surface. Each of the electrode bar insertion holes 32 and 34 has a rectangular profile, however, the shape of the profile of the electrode bar insertion holes is not limited to the illustrated example.

An electrode bar is inserted into each of the electrode bar insertion holes 32 and 34. The electrode bars are respectively caused to contact the electrodes 28 and 30 and apply potential to the liquids 37 and 38.

The first inlet hole 20A described above is made up of the through-holes 10c and 8c, penetrates the plates 10 and 8, and reaches the one end section of the groove 6g of the plate 6, in other words, the upper liquid space 20.

The first outlet hole 20B is made up of the through-holes 10b and 8b, penetrates the plates 10 and 8, and reaches the other end section of the groove 6g of the plate 6, in other words, the upper liquid space 20. The first electrode 28 is provided midway along the first outlet hole 20B.

The second inlet hole 22A is made up of the through-holes 10d, 8d, 6d, and 4d, penetrates the plates 10, 8, 6, and 4, and reaches the one end section of the groove 4g of the plate 4, in other words, the lower liquid space 22.

The second outlet hole 22B is made up of the through-holes 10a, 8a, 6a, and 4a, penetrates the plates 10, 8, 6, and 4, and reaches the other end section of the groove 4g of the plate 4, in other words, the lower liquid space 22. The second electrode 30 is provided midway along the second inlet hole 22A.

The through-hole 10a of the plate 10 being the uppermost layer has a large-diameter portion 10aa in an upper part and a small-diameter portion 10ab in a lower part. The large-diameter portion 10aa and the small-diameter portion 10ab both have a cylindrical shape, a diameter of the large-diameter portion 10aa is larger than a diameter of the small-diameter portion 10ab. The diameter of the small-diameter portion 10ab is larger than a diameter of the through-hole 8a which is directly below the through-hole 10a. The large-diameter portion 10aa is an opening of the second outlet hole 22B and opens on the upper surface of the particle analyzer 1. Therefore, the opening 10aa of the second outlet hole 22B has a larger area than other portions of the second outlet hole 22B.

The through-hole 10b of the plate 10 has a large-diameter portion 10ba in an upper part and a small-diameter portion 10bb in a lower part. The large-diameter portion 10ba and the small-diameter portion 10bb both have a cylindrical shape, a diameter of the large-diameter portion 10ba is larger than a diameter of the small-diameter portion 10bb. The diameter of the small-diameter portion 10bb is larger than a diameter of the through-hole 8b which is directly below the through-hole 10b. The large-diameter portion 10ba is an opening of the first outlet hole 20B and opens on the upper surface of the particle analyzer 1. Therefore, the opening 10ba of the first outlet hole 20B has a larger area than other portions of the first outlet hole 20B.

The through-holes 10c and 10d of the plate 10 have a cylindrical shape with a uniform diameter. The through-holes 10c and 10d have a same diameter as the through-holes 8a, 8b, 8c, and 8d of the plate 8. The through-hole 10c is an opening of the first inlet hole 20A and opens on the upper surface of the particle analyzer 1. The through-hole 10d is an opening of the second inlet hole 22A and opens on the upper surface of the particle analyzer 1.

The plates 2, 4, 6, 8, and 10 can be bonded with an adhesive. However, in order to prevent or reduce undesirable inflow of organic substances to the liquid spaces 20 and 22, the plates 2, 4, 6, 8, and 10 are preferably connected using vacuum ultraviolet rays or oxygen plasma irradiation.

When the chip 24 is formed of a brittle material, in order to prevent breakage of the chip 24, at least one of the plates 4 and 6 around the chip 24 is preferably formed of the elastic material described above. In addition, in order to prevent the liquid inside the connection hole 26 of the chip 24 from leaking, the plate 6 into which the chip 24 is fitted is preferably formed of the elastic material described above and the recessed portion 6h of the plate 6 preferably has a dimension (a dimension in the horizontal direction) which is suitable for the chip 24 to be tightened and fitted. Furthermore, in order to prevent a gap from being created between a lower surface of the chip 24 and an upper surface of the plate 4, a depth of the recessed portion 6h is preferably the same as or slightly greater than a height of the chip 24.

The electrodes 28 and 30 are made of a material with high electrical conductivity. For example, the electrodes 28 and 30 can be formed of silver-silver chloride (Ag/AgCl), platinum, or gold. Alternatively, the electrodes 28 and 30 may be formed of a material containing any of or all of these metals and an elastomer.

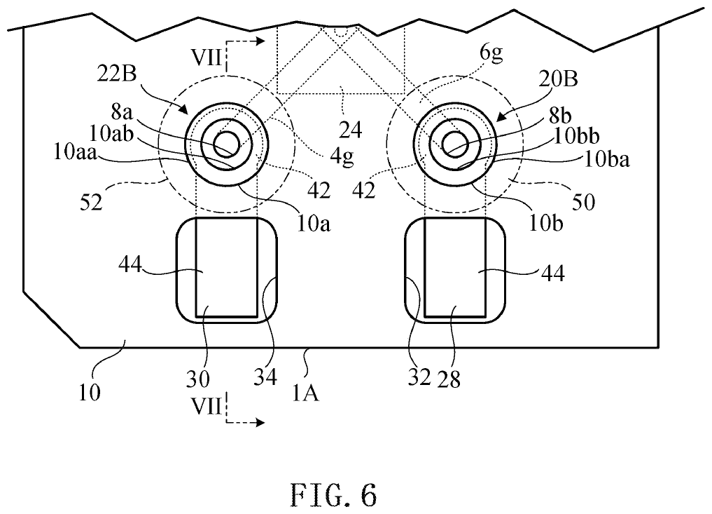

Each of the electrodes 28 and 30 formed on the plate 8 is a flat thin plate and is sandwiched between the two plates 8 and 10. As shown in FIG. 6, each of the electrodes 28 and 30 has an annular part 42 formed around the through-hole 8b or 8a (a part of the hole 20B or the hole 22B) of the plate 8 and an extended part 44 with a rectangular shape which is connected to the annular part 42. A width of the extended part 44 is smaller than an outer diameter of the annular part 42.

The annular part 42 has a through-hole which has approximately the same diameter as the through-holes 8a and 8b. The annular part 42 is formed approximately concentrically with the through-hole 8a or 8b of the plate 8 and approximately concentrically overlaps with the through-hole 10a or 10b of the plate 10 directly above.

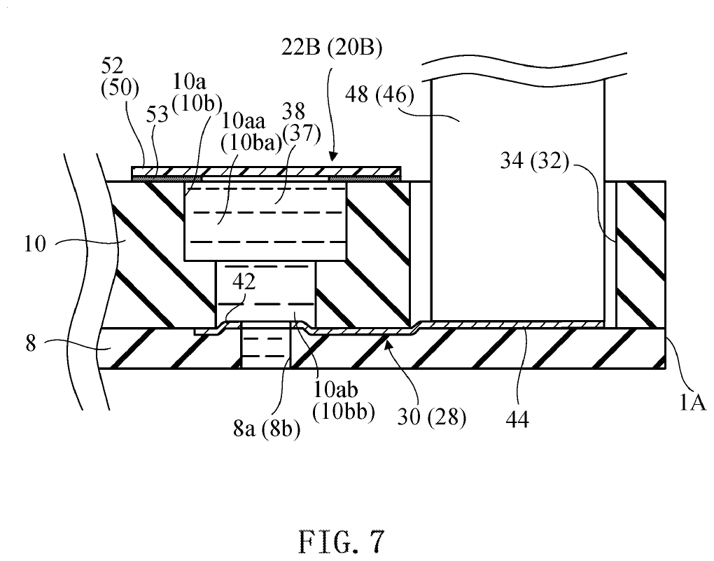

An end of the extended part 44 on an opposite side to the annular part 42 overlaps with the electrode bar insertion hole 32 or 34 of the plate 10 directly above. As shown in FIG. 7, a first electrode bar 46 inserted into the first electrode bar insertion hole 32 is caused to contact the extended part 44 of the first electrode 28, and a second electrode bar 48 inserted into the second electrode bar insertion hole 34 is caused to contact the extended part 44 of the second electrode 30. The electrode bars 46 and 48 are connected to the DC power supply 35 and the ammeter 36 (refer to FIG. 2).

The first outlet hole 20B has the through-hole 10b which is positioned above the first electrode 28 and the through-hole 8b which is positioned below the first electrode 28. The small-diameter portion 10bb of the through-hole 10b has a larger diameter and, by extension, a larger area than the through-hole 8b. An outer diameter of the annular part 42 of the first electrode 28 is larger than the diameter of the small-diameter portion 10bb of the through-hole 10b directly above.

The second outlet hole 22B has the through-hole 10a which is positioned above the second electrode 30 and the through-hole 8a which is positioned below the second electrode 30. The small-diameter portion 10ab of the through-hole 10a has a larger diameter and, by extension, a larger area than the through-hole 8a. An outer diameter of the annular part 42 of the second electrode 30 is larger than the diameter of the small-diameter portion 10ab of the through-hole 10a directly above.

In this manner, the annular part 42 of each electrode overlaps with the through-hole 10b or 10a which has a larger opening area than the through-holes 8b and 8a. Therefore, a large contact area between the liquid injected into the hole and the electrode can be secured and certainty of analysis of a particle can be improved. As shown in FIG. 7, the second electrode 30 contacts the second liquid 38 inside the second outlet hole 22B (through-holes 10a and 8a) by a large area, and the first electrode 28 contacts the first liquid 37 inside the first outlet hole 20B (through-holes 10b and 8b) by a large area.

Since the outer diameter of the annular part 42 is larger than the diameters of the small-diameter portions 10bb and 10ab directly above, even when a position of the annular part 42 slightly deviates from a desired position (in other words, even when precision of the position of the annular part 42 is inaccurate), the annular part 42 overlaps with the small-diameter portions 10bb and 10ab with high certainty. Therefore, in a plurality of particle analyzers 1, a contact area between the liquid injected into the hole and the electrode is constant and certainty of analysis of a particle can be improved.

The particle analyzer 1 further has a first lid 50 and a second lid 52. The first lid 50 is arranged at the opening 10ba of the first outlet hole 20B and closes the opening 10ba. The second lid 52 is arranged at the opening 10aa of the second outlet hole 22B and closes the opening 10aa. The lids 50 and 52 are formed of a film that allows air to pass but does not allow liquids to pass. Therefore, “closes” means that, flowing of liquid through the hole is inhibited, however, passage of air is allowed.

The lids 50 and 52 have a larger area than the openings 10ba and 10aa and respectively cover entireties of the openings 10ba and 10aa. In FIG. 6, the lids 50 and 52 are indicated by imaginary lines.

An example of a film that allows air to pass but does not allow liquids to pass is a porous membrane formed of a hydrophobic resin (for example, PTFE (polytetrafluoroethylene) or PFA (perfluoroalkoxy alkane)). A diameter of a hole of the porous membrane is preferably within a range of 0.1 μm to 10 μm. When the diameter of the hole is smaller than 0.1 μm, flowing of air is inhibited. When the diameter of the hole is larger than 10 μm, there is a possibility that liquid may penetrate the film at high pressure.

As shown in FIG. 7, the lids 50 and 52 are adhered to the upper surface of the plate 10 and, particularly, around the openings 10ba and 10aa by a double-sided adhesive tape 53 with a ring shape. The double-sided adhesive tape 53 makes it easy to dispose the lids 50 and 52 on the particle analyzer 1.

In the present embodiment, the first liquid 37 can be supplied to the upper liquid space 20 through the first inlet hole 20A. A syringe or a pipette can be used to supply the liquid. During supplying of the first liquid 37, air existing in the upper liquid space 20 is exhausted through the first outlet hole 20B and to thereby enable the first liquid 37 to easily enter the upper liquid space 20 from the first inlet hole 20A. The first lid 50 which is formed of the film that allows air to pass but does not allow liquids to pass is provided at the opening 10ba of the first outlet hole 20B. Therefore, even when energy for introducing the first liquid 37 to the upper liquid space 20 is excessively strong, the first liquid 37 is blocked by the first lid 50 and does not scatter to the outside. Since the first lid 50 allows the passage of air, the first lid 50 does not prevent the first liquid 37 from entering the upper liquid space 20 from the first inlet hole 20A.

In a similar manner, the second liquid 38 can be supplied to the lower liquid space 22 through the second inlet hole 22A. A syringe or a pipette can be used to supply the liquid. During supplying of the second liquid 38, air existing in the lower liquid space 22 is exhausted through the second outlet hole 22B and to thereby enable the second liquid 38 to easily enter the lower liquid space 22 from the second inlet hole 22A. The second lid 52 which is formed of the film that allows air to pass but does not allow liquids to pass is provided at the opening 10aa of the second outlet hole 22B. Therefore, even when energy for introducing the second liquid 38 to the lower liquid space 22 is excessively strong, the second liquid 38 is blocked by the second lid 52 and does not scatter to the outside. Since the second lid 52 allows the passage of air, the second lid 52 does not prevent the second liquid 38 from entering the lower liquid space 22 from the second inlet hole 22A.

Therefore, when a liquid contains viruses or bacteria, the liquid can be prevented from squirting out from the particle analyzer 1. In addition, a situation where the first liquid and the second liquid having leaked onto the upper surface of the particle analyzer 1 contact each other and causes precision of analysis of a particle to decline can be prevented.

The applicants used trade name “S-NTF8031J” of the “TEMISH” (registered trademark) series being a porous membrane of PTFE manufactured by NITTO DENKO CORPORATION (Osaka, Japan) as the lids 50 and 52 and tested performance. “S-NTF8031J” is a product provided with the double-sided adhesive tape 53. The plate 10 was formed of VMQ (silicone rubber) containing PDMS.

The diameter of the lids 50 and 52 (outer diameter of the double-sided adhesive tape 53) was 5.6 mm and an inner diameter of the double-sided adhesive tape 53 with a ring shape was 3 mm. The diameter of the openings 10ba and 10aa was 4 mm.

Using a micropipette, purified water was supplied to the upper liquid space 20 through the first inlet hole 20A. The purified water filled the upper liquid space 20 and air having been present in the upper liquid space 20 was exhausted through the first outlet hole 20B. The first lid 50 prevented the purified water from coming out of the first outlet hole 20B. In a similar manner, using a micropipette, purified water was supplied to the lower liquid space 22 through the second inlet hole 22A. The purified water filled the lower liquid space 22 and air having been present in the lower liquid space 22 was exhausted through the second outlet hole 22B. The second lid 52 prevented the purified water from coming out of the second outlet hole 22B.

### Second Embodiment

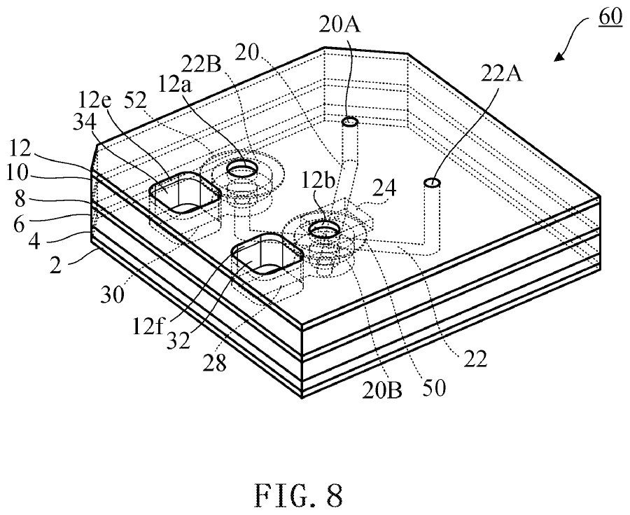

FIG. 8 shows a particle analyzer 60 according to a second embodiment of the present disclosure.

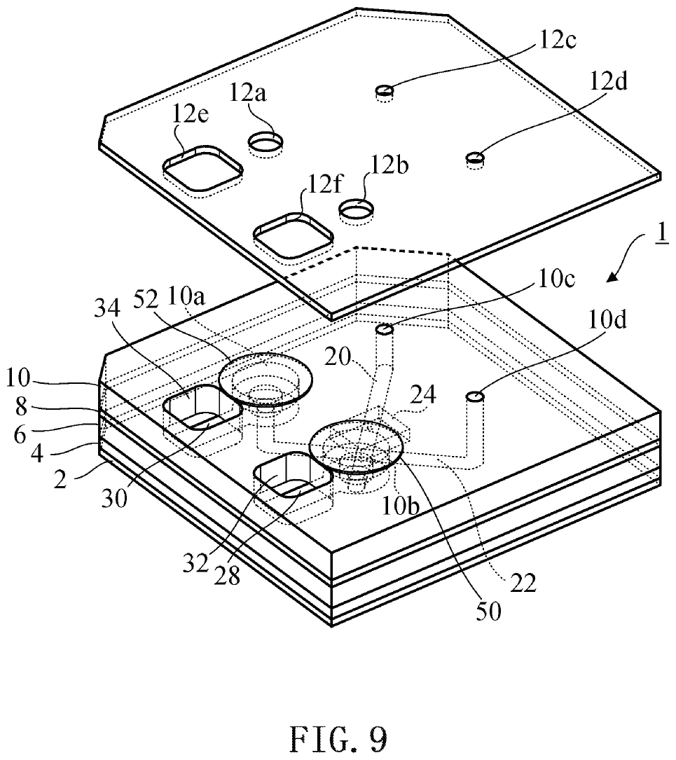

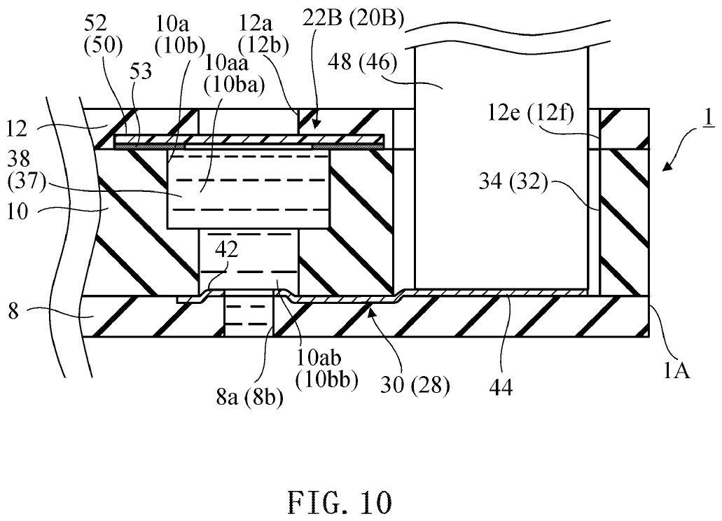

As shown in FIGS. 9 and 10, the particle analyzer 60 has the particle analyzer 1 according to the first embodiment and a plate 12 connected to the upper surface of the particle analyzer 1. Therefore, the lids 50 and 52 are sandwiched between the plate 10 and the plate 12 being connected to each other and are securely fixed to the analyzer. In other words, even when the lids 50 and 52 are subjected to pressure and energy of a liquid introduced to the analyzer, separation of the lids 50 and 52 from the analyzer is reduced.

The plate 12 has a same shape and a same size as the plate 10 and has through-holes 12a, 12b, 12c, 12d, 12e, and 12f.

The through-hole 12a is concentrically aligned with the through-hole 10a of the plate 10 and the second lid 52. The through-hole 12a constitutes the second outlet hole 22B together with the through-holes 10a, 8a, 6a, and 4a. During supplying of the second liquid 38, the air having been present in the lower liquid space 22 is exhausted through the second outlet hole 22B. The through-hole 12a is an opening of the second outlet hole 22B and opens on an upper surface of the particle analyzer 60. Since the through-hole 12a has a smaller diameter than the diameter of the second lid 52, the second lid 52 is in surface contact with and is supported by the plate 12.

The through-hole 12b is concentrically aligned with the through-hole 10b of the plate 10 and the first lid 50. The through-hole 12b constitutes the first outlet hole 20B together with the through-holes 10b and 8b. During supplying of the first liquid 37, the air having been present in the upper liquid space 20 is exhausted through the first outlet hole 20B. The through-hole 12b is an opening of the first outlet hole 20B and opens on the upper surface of the particle analyzer 60. Since the through-hole 12b has a smaller diameter than the diameter of the first lid 50, the first lid 50 is in surface contact with and is supported by the plate 12.

The through-holes 12c and 12d have a same shape and a same size as the through-holes 10c and 10d of the plate 10 and are respectively concentrically aligned with the through-holes 10c and 10d. The through-hole 12c constitutes the first inlet hole 20A together with the through-holes 10c and 8c. The through-hole 12c is an opening of the first inlet hole 20A and opens on the upper surface of the particle analyzer 60. The through-hole 12d constitutes the second inlet hole 22A together with the through-holes 10d, 8d, 6d, and 4d. The through-hole 12d is an opening of the second inlet hole 22A and opens on the upper surface of the particle analyzer 60.

The through-holes 12e and 12f have a same shape and a same size as the electrode bar insertion holes 34 and 32 of the plate 10 and are respectively aligned with the electrode bar insertion holes 34 and 32. Therefore, the first electrode bar 46 inserted into the through-hole 12f and the first electrode bar insertion hole 32 is caused to contact the extended part 44 of the first electrode 28, and the second electrode bar 48 inserted into the through-hole 12e and the second electrode bar insertion hole 34 is caused to contact the extended part 44 of the second electrode 30.

The plate 12 can be bonded to the plate 10 with an adhesive. However, in order to prevent or reduce undesirable mixing of organic substances to the liquids 37 and 38, the plate 12 is preferably connected to the plate 10 using vacuum ultraviolet rays or oxygen plasma irradiation. For example, after manufacturing the plates 10 and 12 from silicone rubber or urethane rubber containing PDMS and sticking the lids 50 and 52 to the plate 10 with the double-sided adhesive tape 53, the plate 12 can be connected to the plate 10 using vacuum ultraviolet rays or oxygen plasma irradiation.

### Third Embodiment

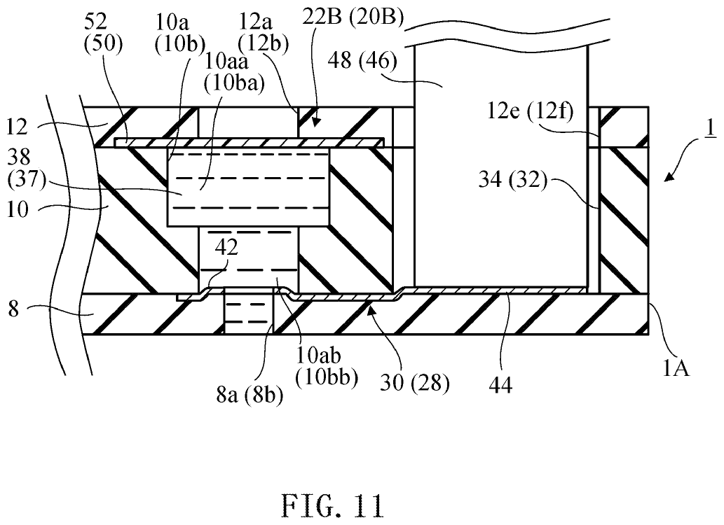

FIG. 11 is a sectional view of a part of a particle analyzer according to a third embodiment of the present disclosure.

As shown in FIG. 10, in the particle analyzer 60 according to the second embodiment, the lids 50 and 52 are adhered to the plate 10 with the double-sided adhesive tape 53. However, in the third embodiment, the double-sided adhesive tape 53 is not used and the lids 50 and 52 directly contact the plate 10. Even if the double-sided adhesive tape 53 is not used, the lids 50 and 52 are sandwiched between the plate 10 and the plate 12 being connected to each other and are securely fixed to the analyzer. Therefore, even when the lids 50 and 52 are subjected to pressure and energy of a liquid introduced to the analyzer, separation of the lids 50 and 52 from the analyzer is reduced.

According to the third embodiment, since the double-sided adhesive tape 53 is not used, undesirable mixing of organic substances to the liquids 37 and 38 can be prevented or reduced.

As the lids 50 and 52, for example, trade name “S-NTF8031” manufactured by NITTO DENKO CORPORATION can be used. “S-NTF8031” is the same as “S-NTF8031J” described earlier with the exception of not being provided with the double-sided adhesive tape 53.

### Fourth Embodiment

A particle analyzer shown in FIG. 11 can be manufactured by a method including preparing the plurality of plates 2, 4, 6, 8, 10, and 12 and connecting the plates 2, 4, 6, 8, 10, and 12 (using, for example, vacuum ultraviolet rays or oxygen plasma irradiation).

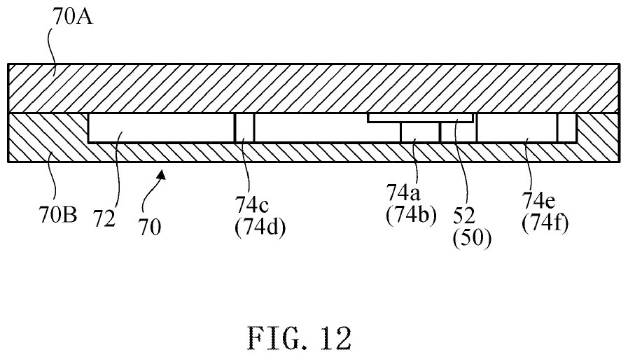

In this case, preparing the plates 2, 4, 6, 8, 10, and 12 includes manufacturing the plate 12 and, at the same time, integrally connecting the lids 50 and 52 to the plate 12 as described below. FIG. 12 shows steps for manufacturing the plate 12 according to the fourth embodiment of the present disclosure.

First, a mold 70 for molding the plate 12 is prepared. The mold 70 has an upper mold 70A and a lower mold 70B. The upper mold 70A is a flat plate and the lower mold 70B has a cavity 72 for forming the plate 12. Columns 74a, 74b, 74c, 74d, 74e, and 74f for respectively forming the through-holes 12a, 12b, 12c, 12d, 12e, and 12f are arranged inside the cavity 72.

The lids 50 and 52 are arranged in the cavity 72 of the lower mold 70B. The lids 50 and 52 are respectively placed on the columns 74b and 74a.

Next, the upper mold 70A is placed on the lower mold 70B. Then, by injection molding or press molding, a material of the plate 12 is arranged in the cavity 72.

The plate 12 is completed by curing the material of the plate 12 and the plate 12, the first lid 50, and the second lid 52 can be integrally connected.

By connecting the plate 12 to which the lids 50 and 52 have been connected with the plate 10, the lids 50 and 52 are sandwiched between the plate 10 and the plate 12 and securely fixed to the analyzer.

According to this method, the first lid 50 and the second lid 52 are easily connected to the plate 12 and the particle analyzer can be easily manufactured. Since the lids 50 and 52 are integrally connected to the plate 12, the lids 50 and 52 are securely fixed to the analyzer.

### Fifth Embodiment

The fourth embodiment may be modified such that a single plate corresponding to the plates 10 and 12 is molded using a mold and, at the same time, the lids 50 and 52 are embedded in the plate.

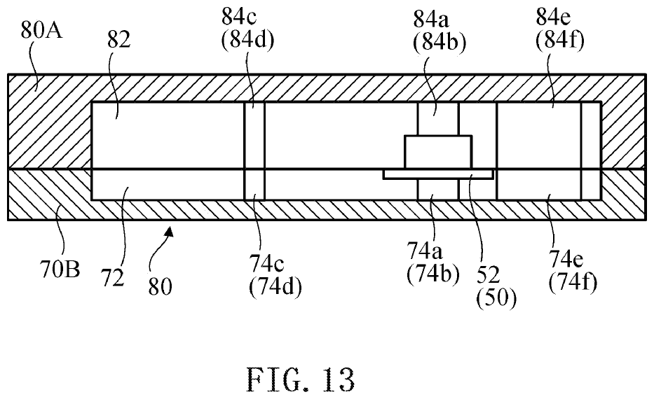

FIG. 13 shows steps for manufacturing the single plate corresponding to the plates 10 and 12 according to a fifth embodiment of the present disclosure.

First, a mold 80 for molding the plate is prepared. The mold 80 has an upper mold 80A and the lower mold 70B. The lower mold 70B is the same as the lower mold 70B according to the fourth embodiment.

The upper mold 80A has a cavity 82 for forming a portion corresponding to the plate 10. Columns 84a, 84b, 84c, 84d, 84e, and 84f for respectively forming the through-holes 10a, 10b, 10c, and 10d and the electrode bar insertion holes 34 and 32 are arranged inside the cavity 82.

The lids 50 and 52 are arranged in the cavity 72 of the lower mold 70B. The lids 50 and 52 are respectively placed on the columns 74b and 74a.

Next, the upper mold 80A is placed on the lower mold 70B. Then, by injection molding or press molding, a material of the plate is arranged in a cavity formed by a combination of the cavities 82 and 72.

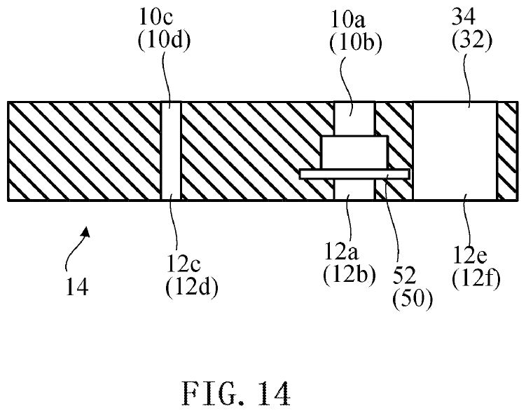

By curing the material of the plate, as shown in FIG. 14, a single plate 14 corresponding to the plates 10 and 12 is completed, the first lid 50 and the second lid 52 are integrally embedded in the plate 14, and both surfaces of the first lid 50 and the second lid 52 contact the plate 14.

According to this method, the first lid 50 and the second lid 52 are easily connected to the plate and the particle analyzer can be easily manufactured. Since the lids 50 and 52 are integrally connected to the plate, the lids 50 and 52 are securely fixed to the analyzer.

Other Modifications

The present disclosure has been illustrated and described above with reference to the preferred embodiments thereof, however, it is understood for a person skilled in the art that changes in forms and details can be made therein without departing from the scope of the disclosure described in the claims. Such changes, modifications, and revisions have to be encompassed in the scope of the present disclosure.

For example, sealing performance between the plates of the particle analyzer may be improved by using a compression mechanism (such as a clamp mechanism, a screw, or a pinch) for constantly compressing the particle analyzer in the vertical direction.

The number of plates included in the particle analyzer is not limited to the embodiments described above. The upper liquid space 20 is formed by the groove 6g formed in the single plate 6 in the embodiments described above, however, the upper liquid space 20 may be formed in a plurality of plates (for example, the plates 6 and 8). The lower liquid space 22 is formed by the groove 4g formed in the single plate 4 in the embodiments described above, however, the lower liquid space 22 may be formed in a plurality of plates (for example, the plates 4 and 2). The chip 24 including the connection hole 26 is arranged inside the single plate 6 in the embodiments described above, however, the chip 24 may be arranged inside a plurality of plates (for example, the plates 6 and 4).

The extended part 44 of the electrodes 28 and 30 is a rectangle with a uniform width in the embodiments described above. However, the extended part 44 may have a portion with a wide width and a portion with a narrow width or the width of the extended part 44 may gradually decrease or gradually increase as going toward the side surface 1A.

Aspects of the present disclosure are also described in the numbered items presented below.
Item 1. A particle analyzer, characterized by including:
an upper liquid space in which a first liquid is to be stored;
a lower liquid space which is arranged below the upper liquid space and in which a second liquid is to be stored;
a connection hole connecting the upper liquid space and the lower liquid space to each other;
a first inlet hole which has an opening that opens on an upper surface of the particle analyzer, which extends from the upper surface to the upper liquid space, and which is for supplying the first liquid to the upper liquid space;
a first outlet hole which has an opening that opens on the upper surface, which extends from the upper surface to the upper liquid space, and through which air is to be exhausted from the upper liquid space;
a second inlet hole which has an opening that opens on the upper surface, which extends from the upper surface to the lower liquid space, and which is for supplying the second liquid to the lower liquid space;
a second outlet hole which has an opening that opens on the upper surface, which extends from the upper surface to the lower liquid space, and through which air is to be exhausted from the lower liquid space;
a first electrode which applies a potential to the first liquid in the upper liquid space;
a second electrode which applies a potential to the second liquid in the lower liquid space;
a first lid which is arranged at the opening of the first outlet hole and which is formed of a film that allows air to pass but does not allow liquids to pass; and
a second lid which is arranged at the opening of the second outlet hole and which is formed of a film that allows air to pass but does not allow liquids to pass.
Item 2. The particle analyzer according to item 1, characterized in that
the first lid and the second lid are formed of a porous membrane made of a hydrophobic resin.
Item 3. The particle analyzer according to item 1 or 2, characterized by including
a plurality of plates being stacked and connected, wherein
the first lid and the second lid are sandwiched between two of the plates.

According to this item, the first lid and the second lid are securely fixed to the analyzer.
Item 4. The particle analyzer according to any one of items 1 to 3, characterized by including
a plurality of plates being stacked and connected, wherein
the first lid and the second lid are fixed to one of the plates by a double-sided adhesive tape.

According to this item, the first lid and the second lid are easily disposed in the analyzer.
Item 5. The particle analyzer according to item 1 or 2, characterized by including
a plurality of plates being stacked and connected, wherein
the first lid and the second lid are embedded in one of the plates, and both surfaces of the first lid and the second lid contact the plate.

According to this item, the first lid and the second lid are securely fixed to the analyzer.
Item 6. A method of manufacturing the particle analyzer according to item 3 or 5, the method characterized by including:
preparing a plurality of plates; and
connecting the plates, wherein
preparing the plates includes arranging the first lid and the second lid inside a mold for molding one of the plates, arranging a material of the plate inside the mold, and curing the material of the plate to connect the plate to the first lid and the second lid.

According to this method, the first lid and the second lid are easily connected to the plate and the particle analyzer can be easily manufactured. Since the first lid and the second lid are integrally connected to the plate, the lids are securely fixed to the analyzer.

1. A particle analyzer, comprising:
an upper liquid space in which a first liquid is to be stored;
a lower liquid space which is arranged below the upper liquid space and in which a second liquid is to be stored;
a connection hole connecting the upper liquid space and the lower liquid space to each other;
a first inlet hole which has an opening that opens on an upper surface of the particle analyzer, which extends from the upper surface to the upper liquid space, and which is for supplying the first liquid to the upper liquid space;
a first outlet hole which has an opening that opens on the upper surface, which extends from the upper surface to the upper liquid space, and through which air is to be exhausted from the upper liquid space;
a second inlet hole which has an opening that opens on the upper surface, which extends from the upper surface to the lower liquid space, and which is for supplying the second liquid to the lower liquid space;
a second outlet hole which has an opening that opens on the upper surface, which extends from the upper surface to the lower liquid space, and through which air is to be exhausted from the lower liquid space;
a first electrode applying a potential to the first liquid in the upper liquid space;
a second electrode applying a potential to the second liquid in the lower liquid space;
a first lid which is arranged at the opening of the first outlet hole and which is formed of a film allowing air to pass but not allowing liquids to pass; and
a second lid which is arranged at the opening of the second outlet hole and which is formed of a film allowing air to pass but not allowing liquids to pass.

2. The particle analyzer according to claim 1, wherein,
the first lid and the second lid are formed of a porous membrane made of a hydrophobic resin.

3. The particle analyzer according to claim 1, further comprising
a plurality of plates being stacked and connected, wherein
the first lid and the second lid are sandwiched between two of the plates.

4. The particle analyzer according to claim 1, further comprising
a plurality of plates being stacked and connected, wherein
the first lid and the second lid are fixed to one of the plates by a double-sided adhesive tape.

5. The particle analyzer according to claim 1, further comprising
a plurality of plates being stacked and connected, wherein
the first lid and the second lid are embedded in one of the plates, and both surfaces of the first lid and the second lid contact the plate.

6. A method of manufacturing the particle analyzer according to claim 1, the method comprising:
preparing a plurality of plates; and
connecting the plates, wherein
preparing the plates includes arranging the first lid and the second lid inside a mold for molding one of the plates, arranging a material of the plate inside the mold, and curing the material of the plate to connect the plate to the first lid and the second lid.
